(19) United States
(12) Patent Application Publication
(10) Pub. No.: US 2022/0046520 A1
(43) Pub. Date: Feb. 10, 2022

(54) NETWORK CONFIGURATION APPARATUS, SERVER, AND COMMUNICATION SYSTEM

(71) Applicant: Sony Group Corporation, Tokyo (JP)

(72) Inventor: Hiroaki TAKANO, Tokyo (JP)

(73) Assignee: Sony Group Corporation, Tokyo (JP)

(21) Appl. No.: 17/416,529

(22) PCT Filed: Nov. 29, 2019
(86) PCT No.: PCT/JP2019/046691

§ 371 Date: Jun. 21, 2021

(30) Foreign Application Priority Data
Jan. 23, 2019 (JP) 2019-009628

(51) Int. Cl. H04W 48/14; H04W 88/10; H04W 48/20; H04W 76/11

(52) U.S. Cl. CPC H04W 48/14; H04W 76/11; H04W 48/20; H04W 88/10

(57) ABSTRACT

A new network function is constituted and arranged in response to a request.

A base station device transmits a shared network identifier that is commonly used. Upon receipt of the shared network identifier, the communication device issues a connection request using own connection destination information. A server acquires and supplies a unique network identifier corresponding to the connection destination information associated with the connection request. The network configuration apparatus constitutes and arranges a network function on the basis of the unique network identifier that has been supplied.

### TECHNICAL FIELD

The present technology relates to a network configuration apparatus. Specifically, the present technology relates to a network configuration apparatus that constitutes and arranges a network function, a server, a communication system, a method of processing in the same, and a program that causes a computer to execute the method.

### BACKGROUND ART

Mobile communication systems such as 4G and 5G include wireless systems and core systems. In order to share a wireless system with a plurality of operators (providers), roaming technology using a wireless system of a partner provider has been conventionally used. For example, an apparatus that shares a base station for wireless communication has been proposed (see, for example, Patent Document 1).

### CITATION LIST

### Patent Document

Patent Document 1: Japanese Patent Application National Publication (Laid-Open) No. 2013-504924

### SUMMARY OF THE INVENTION

### Problems to be Solved by the Invention

In the above roaming, a network identifier for each provider is broadcast from the shared base station.

However, in a case where the number of providers becomes enormous, there is a problem that broadcasting all the network identifiers causes an overhead. Furthermore, the roaming presupposes procedures in advance, and there is a problem that it is complex and impractical to make a roaming contract among a huge number of providers in a case where an owner of the base station is a hotel or an individual.

The present technology has been created in view of such circumstances and aims to newly constitute and arrange a network function as required.

### Solutions to Problems

The present technology has been made to solve the above problems, and a first aspect of the present technology is a communication system including a base station device configured to transmit a shared network identifier that is commonly used, a communication device configured to issue a connection request using own connection destination information upon receipt of the shared network identifier, a server configured to acquire and supply a unique network identifier corresponding to the connection destination information associated with the connection request, and a network configuration apparatus configured to constitute and arrange a network function on the basis of the unique network identifier that has been supplied. This configuration has the effect that the server supplies a unique network identifier corresponding to the connection destination information of the communication device that has received the shared network identifier, and the network configuration apparatus constitutes the network function on the basis of the unique network identifier.

Furthermore, a second aspect of the present technology is a network configuration apparatus that is supplied with a unique network identifier corresponding to information provided by a communication device, and then constitutes and arranges a network function on the basis of the unique network identifier that has been supplied. This configuration has the effect that the network function is arranged on the basis of the unique network identifier corresponding to the information provided by the communication device.

Furthermore, in the second aspect, the information provided by the communication device may be the connection destination information of the communication device, and the connection destination information may be an access point name (APN). This configuration has the effect that a unique network identifier is specified by using information that has been originally used to specify the access point name in the network.

Furthermore, in the second aspect, the unique network identifier may be supplied from a server as corresponding to the information provided by the communication device. This configuration has the effect that the server is used to link the information provided by the communication device with the unique network identifier.

Furthermore, in the second aspect, the information provided by the communication device may be provided to the server by a base station device that transmits a shared network identifier that is commonly used. This configuration has the effect that the network function is arranged via the base station device even if there is no available network function.

Furthermore, in the second aspect, the information provided by the communication device may include SIM information, and the base station device may be authenticated as valid on the basis of the SIM information. This configuration has the effect that the base station device is authenticated as valid when the information that has been provided by the communication device is provided by the communication device.

Furthermore, in the second aspect, the information provided by the communication device may be provided to the server by a network corresponding to a shared network identifier that is commonly used. This configuration has the effect that the network function is arranged via the available network without making any changes to the existing base station device.

Furthermore, in the second aspect, the information provided by the communication device may include SIM information, and the network corresponding to the shared network identifier may be authenticated as valid on the basis of the SIM information. This configuration has the effect that the network is authenticated as valid when the information that has been provided by the communication device is provided by the network.

Furthermore, in the second aspect, it is assumed that the network function arranged on the basis of the unique network identifier is, for example, a new core network. In this case, information associated with where the new core network is to be arranged may be received. Furthermore, the information associated with where the new core network is to be arranged may include information associated with a location of the base station device that transmits the shared network identifier that is commonly used, and the new core network may be arranged at a predetermined distance with respect to the location of the base station device.

Further, in the second aspect, it is assumed that the network function arranged on the basis of the unique network identifier is, for another example, a new network slice of the existing core network.

Furthermore, in the second aspect, the information may be provided by the communication device, and then an application layer may perform a use permission procedure necessary for using a base station device. This configuration has the effect that the use permission procedure is performed by the application layer for each communication device as needed. In this case, the use permission procedure may include a payment procedure of a cost of using the base station device.

Furthermore, in the second aspect, the network function may be arranged on the basis of the unique network identifier, and then the unique network identifier may be transmitted from a plurality of base station devices in the same group. This configuration has the effect that when the communication device moves, even if the communication device deviates from a communication range of one base station device, wireless communication is maintained in a communication range of another base station device. In this case, it is desirable that ones of the plurality of base station devices in the group be installed adjacent to each other within a predetermined range.

Furthermore, in a state where a plurality of network functions is arranged, a use permission procedure necessary for using another base station device among the plurality of base station devices may be performed among the plurality of network functions. This configuration has the effect that the service of the network function is maintained without creating a new network function.

Furthermore, a third aspect of the present technology is a server including a storage unit configured to store connection destination information of a communication device and a unique network identifier corresponding to the connection destination information in association with each other, and a supply unit configured to acquire the unique network identifier corresponding to the connection destination information provided by the communication device from the storage unit and configured to supply the unique network identifier. This configuration has the effect that the unique network identifier corresponding to the connection destination information provided by the communication device is supplied from the server.

### BRIEF DESCRIPTION OF DRAWINGS

FIG. 1 is a diagram of an overall configuration example of a communication system according to an embodiment of the present technology.

FIG. 2 is a diagram of an example of a relationship between a cooperation server 60 and an application 50 in the embodiment of the present technology.

FIG. 3 is a sequence diagram of an example of processing of a communication system according to a first embodiment of the present technology.

FIG. 4 is a diagram of an example of a network slice in a second embodiment of the present technology.

FIG. 5 is a diagram of a functional configuration example of a core network 10 according to the second embodiment of the present technology.

FIG. 6 is a sequence diagram of an example of processing of a communication system according to the second embodiment of the present technology.

FIG. 7 is a diagram of an example of a network slice generation process according to the second embodiment of the present technology.

FIG. 8 is a diagram of an example of a network slice generation process according to a third embodiment of the present technology.

FIG. 9 is a sequence diagram of an example of processing of a communication system according to the third embodiment of the present technology.

FIG. 10 is a sequence diagram of an example of processing of a communication system according to a fourth embodiment of the present technology.

FIG. 11 is a sequence diagram of an example of processing of a communication system according to a fifth embodiment of the present technology.

### MODE FOR CARRYING OUT THE INVENTION

Hereinafter, embodiments for implementing the present technology (hereinafter referred to as embodiments) will be described. The description will be made in the following order.

1. First Embodiment (Example of Arranging a Core Network from a State where there is No Default Core Network)

2. Second Embodiment (Example of Arranging a New Core Network via a Default Core Network)

3. Third Embodiment (Example of Receiving Permission to use a Base Station Device for Each terminal)

4. Fourth Embodiment (Example of Grouping Base Station Devices)

5. Fifth Embodiment (Example of Performing a Procedure for Permission of use Between the Core Networks)

### 1. First Embodiment

[Communication System]

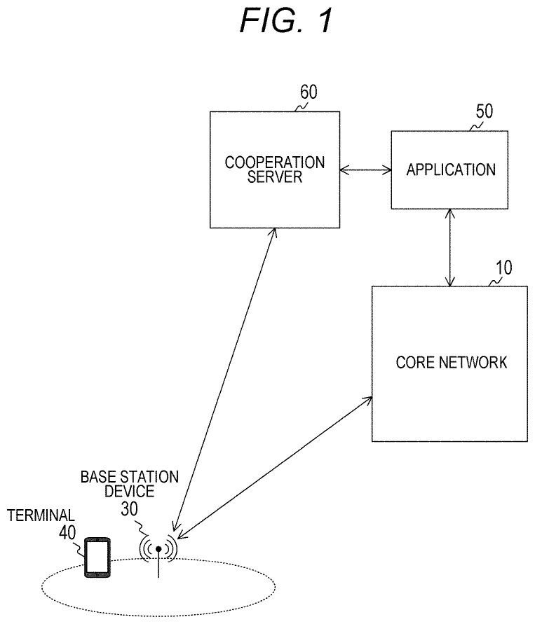

FIG. 1 is a diagram of an overall configuration example of a communication system according to an embodiment of the present technology. This communication system includes a core network 10 in the third generation partnership project (3GPP) standard, a base station device 30, an application 50, and a cooperation server 60.

The core network 10 is a backbone network that constitutes a public network, and for example, an evolved packet core (EPC) or a 5G core network (5G next generation core) is assumed.

The base station device 30 is a base station that constitutes a radio access network (RAN) and provides a network connection to a terminal 40. The base station device 30 connects to the core network 10 via a backhaul line. The backhaul line is a line that relays an access line of the base station device 30 and a backbone line of the core network 10 wirelessly or by wire.

The base station device 30 periodically broadcasts system information. This system information includes a network identifier of the network connected to the base station device 30. The network identifier is an identifier (PLMN-ID) of a provider (operator) that provides a communication service of a public land mobile network (PLMN).

Base stations that can be used up to 100 GHz, such as 5G, have high straightness of radio waves, and it is therefore difficult to transmit and receive data from the base station arranged outdoors to a terminal arranged indoors with high throughput. Basically, it is desirable to arrange the base station and the terminal in an environment where direct waves can be seen. In a case where a base station is arranged in an indoor office, a hotel, or a private residence, it is considered important to share the base station with a plurality of operators due to the greatly limited location. The PLMN-ID described above is used to distinguish between the plurality of operators. Conventional base stations are able to broadcast several types of PLMN-IDs. Thus, the terminal is able to select the PLMN-ID and connect to the network via the base station. However, even though two or three PLMN-IDs can be handled, the overhead causes a problem when hundreds of kinds of PLMN-IDs are broadcast, and the PLMN-IDs cannot be handled. Therefore, the number of operators who share is limited to two or three.

Furthermore, in a case where a base station device is used as a shared base station, it is natural for each provider to prepare a core network connected to the base station device. This is because the core network includes subscriber information, which is information unique to the provider. However, in a case where which provider's terminal will connect to the shared base station is not known, how to prepare the core network may not be known. Normally, even if one core network is set up by default and connected to a base station, there is no point in setting up the core network after all if roaming and the like cannot be used.

Note that, as another related technology, a technology of on-demand system information is known in which minimum system information is broadcast and other detailed system information is provided from a network side in response to a request from a terminal. In this case, PLMN-ID is always broadcast periodically as the minimum system information. In the on-demand system information, additional information can be requested, but that information is not provided periodically. For example, if an additional PLMN-ID is requested, the PLMN-ID can be received only once, but whether the PLMN-ID information is retained in the base station or core network is unknown. Retaining hundreds of PLMN-ID information in the core network is inefficient in a system including a locally located base station or core network.

Thus, in this embodiment, the base station device 30 transmits the system information including the commonly used shared network identifier. This shared network identifier is a common network identifier that can be commonly used by a plurality of providers. The current mobile virtual network operator (MVNO) distinguishes networks by different access point names (APNs) in one PLMN-ID. However, these MVNOs are borrowed from a core network, and are actually operating on the core network of the mobile network operator (MNO). A so-called full MVNO having prepared a completely unique core network needs to prepare a different PLMN-ID. In a case where there are a large number of providers such as such full MVNOs, the base station device 30 does not have to provide a significantly large number of PLMN-IDs by using a shared network identifier for identifying the full MVNO instead of preparing a large number of individual PLMN-IDs.

The terminal 40 is a user terminal (UE: user equipment) used by a user. Upon receipt of the system information, the terminal 40 issues a connection request by using the shared network identifier included in the system information and its own connection destination information. The connection destination information of the terminal 40 is, for example, the above access point name (APN). In general, the terminal attempts to connect to the base station broadcasting the PLMN-ID that has been last connected after power is turned on. In a case where there is no such base station, the terminal attempts to connect to a home PLMN-ID registered in advance on that terminal. Moreover, in a case where there is no such base station, the terminal generally tries a list of PLMN-IDs with roaming contracts in order for connection. In a conventional shared RAN (RAN sharing) in which the base station and a frequency used at the base station are shared, the PLMN-ID corresponding to the PLMN of the terminal is not provided, and the roaming contract is complex. It may not be therefore possible to connect after trying the list of roaming contracts in order. In this regard, these problems are solved by issuing a connection request using the shared network identifier and its own connection destination information in this embodiment. Note that the terminal 40 is an example of a communication device described in the claims.

The application 50 is an application of a provider that provides a communication service. There may be thousands of providers that provide communication services in the future. Note that the application 50 is an example of a network configuration apparatus described in the claims. The application 50 can be arranged inside or outside the core network 10. Thus, the network configuration apparatus described in the claims can also include an application of the core network 10 as described later and processing in an application layer.

The cooperation server 60 is a server that supplies a unique network identifier in response to connection destination information associated with a connection request from the terminal 40. That is, the cooperation server 60 associates the connection destination information with the unique network identifier. This unique network identifier is different from the shared network identifier, and is a unique network identifier for each provider. The cooperation server 60 is arranged on a cloud, for example. With this cooperation server 60, even if there is no roaming contract, the provider can be specified from the connection destination information (APN) that the terminal 40 is to connect to. That is, the cooperation server 60 has a role of bundling thousands of providers that may exist in the future as described above. Note that the cooperation server 60 is an example of a server described in the claims.

[Cooperation Server and Application]

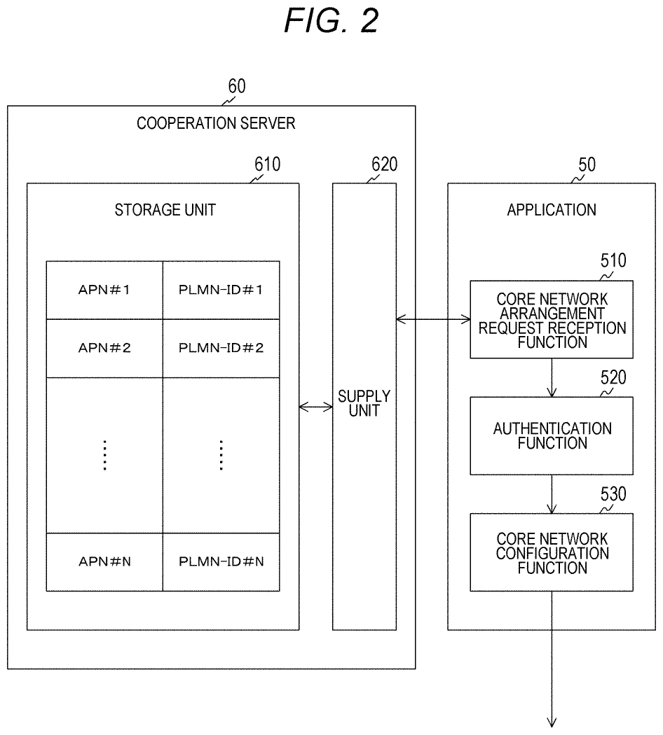

FIG. 2 is a diagram of an example of a relationship between the cooperation server 60 and the application 50 in the embodiment of the present technology.

The cooperation server 60 includes a storage unit 610 and a supply unit 620. The storage unit 610 stores the connection destination information of the terminal 40 in association with the unique network identifier corresponding to the connection destination information. In this example, an example is shown in which N pairs of access point name (APN) of the terminal 40 and the PLMN-ID of the network are stored. With this configuration, the cooperation server 60 can link the connection destination information of the terminal 40 with the unique network identifier corresponding to the connection destination information.

The supply unit 620 acquires the network identifier stored in the storage unit 610 in association with the connection destination information on the basis of the connection destination information provided from the terminal 40, and supplies the network identifier to the application 50.

The application 50 includes a core network arrangement request reception function 510, an authentication function 520, and a core network configuration function 530 as functions associated with the cooperation server 60. Note that these functions may be provided either inside or outside the cooperation server 60.

The core network arrangement request reception function 510 is a function of receiving a core network arrangement request from the base station device 30.

The authentication function 520 is a function of determining whether or not the arrangement request received by the core network arrangement request reception function 510 is a valid arrangement request. The authentication function 520 determines whether or not the arrangement request is valid by performing authentication with the base station device 30.

Note that in the authentication by the authentication function 520, the base station device 30 may be considered valid by authentication of the terminal 40 on the basis of subscriber identity module (SIM) information such as the international mobile subscriber identity (IMSI) and the like when the terminal 40 issues a connection request. This is because if the relationship of rights whether or not the PLMN can be used as a shared base station of the base station device 30 is to be confirmed, then, the adjustment of the contract relationship becomes complicated similarly in roaming.

The core network configuration function 530 is a function of constituting and arranging (deploying or activating) the core network on the basis of the network identifier supplied from the supply unit 620.

[Operation]

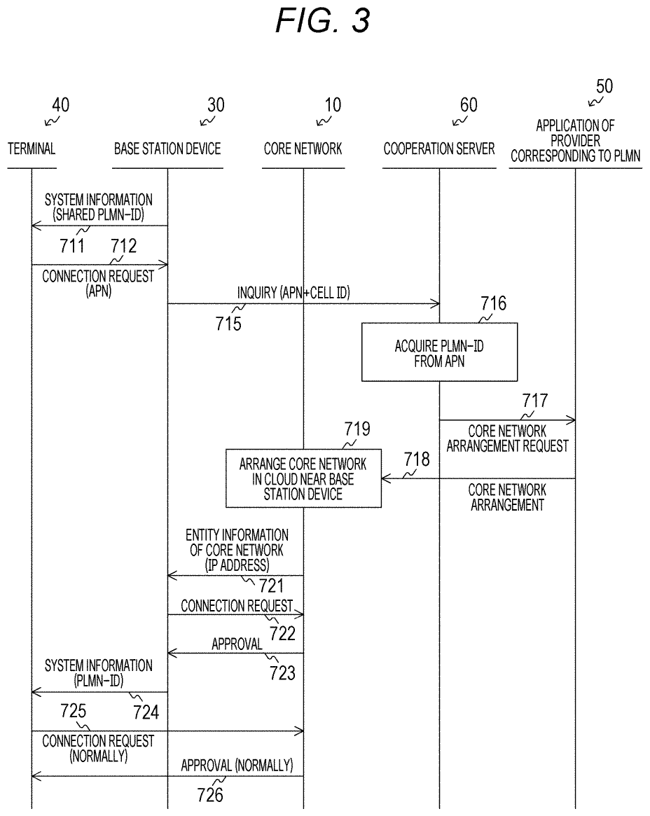

FIG. 3 is a sequence diagram of an example of processing of the communication system according to the first embodiment of the present technology.

The base station device 30 periodically broadcasts the system information including the shared network identifier (711). The terminal 40 that has received the system information including the shared network identifier attempts to connect to the base station device 30. At that time, if an available network identifier other than the shared network identifier is not broadcast, a connection request (attach request) including the connection destination information (APN) of the terminal 40 is transmitted to the base station device 30 (712).

Note that such a usage of the APN is different from the conventional usage. Conventionally, the usage is for identifying the APN in the known PLMN, but the usage in this embodiment is for identifying the actual PLMN-ID by the APN. This is because the core network for terminal 40 has not yet been arranged at this stage.

Upon receipt of the connection request from the terminal 40, the base station device 30 inquires the cooperation server 60 for the PLMN-ID (715). This inquiry includes an identifier (cell ID) of the base station device 30 and the connection destination information (APN) of the terminal 40.

Upon receipt of the inquiry from the base station device 30, the cooperation server 60 acquires the PLMN-ID corresponding to the connection destination information (APN) of the terminal 40 (716). Then, the application 50 of the provider corresponding to the PLMN-ID is provided with information on the location of the base station device 30 that requires the core network, and is notified that the core network is required at the location (717). The location of the base station device 30 can be determined from the cell ID of the base station device 30. This may be an internet protocol (IP) address or the like.

The application 50 of the notified provider constitutes and arranges the core network 10 at an edge of a cloud near the location of the base station device 30 (718 and 719). That is, the core network 10 is arranged at a predetermined distance with respect to the location of the base station device 30.

In order to connect the arranged core network 10 and the base station device 30, the core network 10 provides the base station device 30 with information on a network entity of the core network 10 (721). Here, as the information on the network entity, for example, an IP address of an entity that handles a mobility management entity (MME) or a user plane is assumed.

The base station device 30 issues a connection request (set up request) to the core network 10 (722). The core network 10 transmits an approval (accept-in) to the connection request to the base station device 30 (723). With this configuration, the connection between the base station device 30 and the newly arranged core network 10 is completed.

The base station device 30 broadcasts the system information including the unique network identifier corresponding to the provider (724). The terminal 40 transmits a connection request by a normal operation (725). Then, upon acquisition of the approval to the connection request from the core network 10 (726), the connection of the terminal 40 is completed.

As described above, the first embodiment of the present technology allows the service of the provider's own core network 10 to be provided to the terminal 40 without requiring a roaming contract.

### 2. Second Embodiment

In the first embodiment described above, it is assumed at an initial stage that the core network 10 available from the terminal 40 does not exist. In the second embodiment, it is assumed that a network slice of the core network 10 is newly arranged in a state where the default core network 10 available from the terminal 40 exists.

[Network Slice]

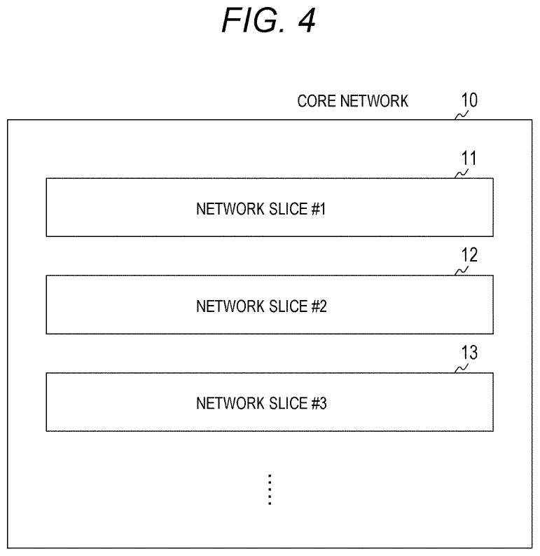

FIG. 4 is a diagram of an example of the network slice in the second embodiment of the present technology.

The core network 10 is provided with a plurality of network slices in order to efficiently accommodate communication modes of various use cases. For example, it can be assumed that a network slice #1 (11) is for low-latency networks, a network slice #2 (12) is for MTCs that facilitate communication between network functions, and a network slice #3 (13) is for facilitating device-to-device communication.

In relation to independence of the network slice of the core network 10, a multi-protocol label switch (MPLS) used to realize a virtual private network (VPN) is used. Normally, in routing, each switch refers to a destination IP header for routing. The MPLS assigns a label, and a MPLS-compatible switch refers to the label for routing. This makes it possible to explicitly specify a route through the network for each VPN. Similarly, for achieving network slicing, a plurality of networks can be virtually arranged by assigning labels that follow different routes to each network slice. The networks that are not physically separated are used, and it is therefore possible to isolate the network slices by performing control that guarantees a bandwidth between the VPNs for each network slice.

[Communication System]

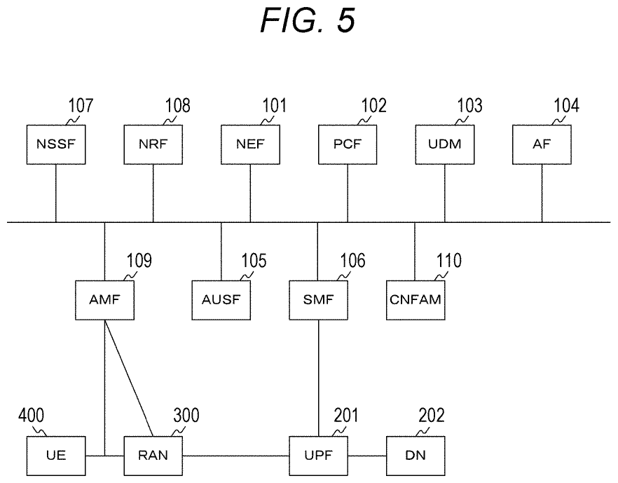

FIG. 5 is a diagram of a functional configuration example of the core network 10 according to the second embodiment of the present technology. Note that the overall configuration of the communication system is similar to that of the first embodiment described above, detailed description thereof will be omitted.

A UE 400 corresponds to the terminal 40 described above. An RAN 300 corresponds to the above base station device 30. Here, a CNFAM 110 is a new function in this embodiment, and the others are existing network functions of 3GPP.

These network functions are connected by bus and can receive a predetermined service by receiving a response to a request (SBA: service based architecture). A protocol in this SBA is based on HTTP/2, and information can be exchanged in a JavaScript object notation (JSON) format (JavaScript is a registered trademark).

An application function (AF) 104 interacts with the core network 10 to supply services. The AF 104 can transmit a service request and receive a response from each network function via an NEF 101. Basic usage is for the AF 104 to acquire the information of each network function. The AF 104 can acquire information such as a position, time zone, connection status (idle status and RRC connection status), and the like of the UE 400 from the core network 10. Note that the AF 104 can be arranged inside or outside the core network 10.

The network exposure function (NEF) 101 is an interface that provides information on each function in the core network 10 to the AF 104 inside or outside the core network 10.

A policy control function (PCF) 102 provides a quality of service (QoS) policy.

A unified data management (UDM) 103 performs control for storing data in the core network 10.

An authentication server function (AUSF) 105 has a function of authenticating whether or not the UE 400 is a reliable terminal at time of an attach request.

A session management function (SMF) 106 has a function of processing the attach request of the UE 400.

A network slice selection function (NSSF) 107 has a function of allocating network slices to the UE 400.

A network repository function (NRF) 108 performs service discovery.

An access and mobility management function (AMF) 109 controls hand over.

The core network function activation management (CNFAM) 110 is a new entity in this embodiment, and manages the configuration and arrangement of the core network 10. The application 50 arranged outside or inside the core network 10 provides information for arranging the core network unique to the provider via this CNFAM 110, and requests for arrangement of the core network as a network slice.

A user plane function (UPF) 201 is a connection point with a data network (DN) 202.

[Operation]

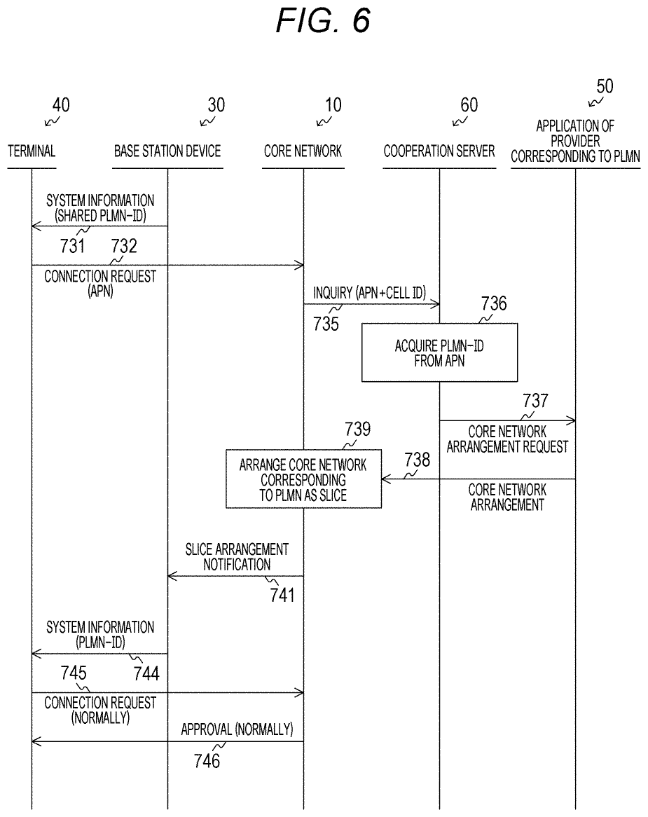

FIG. 6 is a sequence diagram of an example of processing of the communication system according to the second embodiment of the present technology.

The base station device 30 periodically broadcasts the system information including the network identifier of the default core network 10 as a shared network identifier (731).

The terminal 40 transmits a connection request to the core network 10 using the network identifier of the default core network 10 (732). That is, the connection can be requested not to the base station device 30 as in the first embodiment described above, but to the core network 10 as in the conventional case. The connection request includes the connection destination information (APN) of the terminal 40, as in the first embodiment described above.

Upon receipt of the connection request from the terminal 40, the core network 10 inquires the cooperation server 60 for the PLMN-ID (735). This inquiry includes an identifier (cell ID) of the base station device 30 and the connection destination information (APN) of the terminal 40.

Upon receipt of the inquiry from the core network 10, the cooperation server 60 acquires the PLMN-ID corresponding to the connection destination information (APN) of the terminal 40 (736). Then, the application 50 of the provider corresponding to the PLMN-ID is provided with information on the location that requires the core network, and is notified that the core network is required at the location (737).

Upon receipt of the notification, the application 50 of the provider requests the core network 10 to arrange the core network corresponding to the PLMN-ID (738). With this configuration, the network slice in the core network 10 is arranged as the core network corresponding to the PLMN-ID (739).

The core network 10 notifies the base station device 30 that a new core network of PLMN-ID corresponding to the requested connection destination information (APN) has been arrange in a form of a network slice (741).

The base station device 30 broadcasts the system information including the unique network identifier corresponding to the provider (744). The terminal 40 transmits a connection request by a normal operation (745). Then, upon acquisition of the approval to the connection request from the core network 10 (746), the connection of the terminal 40 is completed.

Note that in the second embodiment, the core network arrangement request reception function 510 receives the core network arrangement request from the default core network 10. Then, the authentication function 520 determines whether or not the arrangement request received by the core network arrangement request reception function 510 is a valid arrangement request by performing authentication with the default core network 10. In the authentication by the authentication function 520, the default core network 10 may be regarded as valid by authenticating the terminal 40 on the basis of the SIM information such as the IMSI and the like when the terminal 40 issues a connection request.

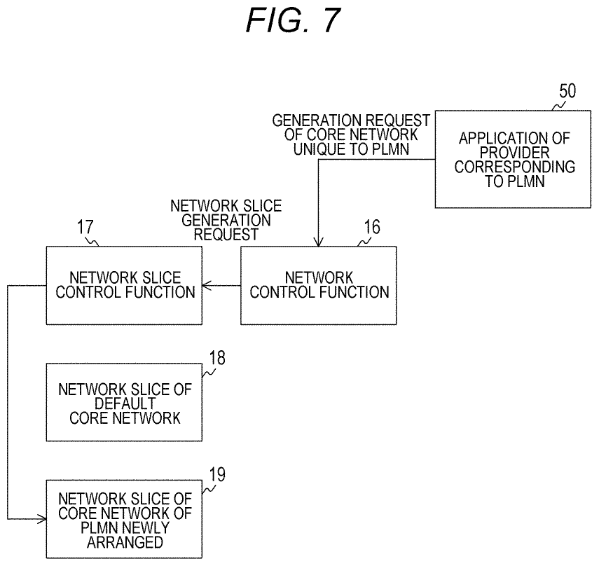

FIG. 7 is a diagram of an example of a network slice generation process according to the second embodiment of the present technology.

As described above (738), in response to a request from the application 50 to the default core network 10 to arrange the network corresponding to the PLMN-ID, a network slice is generated in the core network 10 as follows.

A network control function 16 requests a network slice control function 17 to generate a network slice. With this configuration, the network slice control function 17 generates a new network slice 19 as a core network corresponding to the PLMN-ID, in addition to a network slice 18 of the default core network 10.

[Information Required for Network Slice Arrangement]

Here is an example of information required to arrange a new network slice in the core network 10.

A first example is a use case of the network slice regarding whether the use is intended for broadband or internet of things (IoT). Further, information associated with network slice capacity, such as throughput (for example, Gbps/s) and the number of simultaneously connected devices, is also useful. Furthermore, a billing method such as a packet counting method can be considered. In addition, a location of a data network (APN) provided by the provider has to be indicated by the IP address. In addition to these, it is also necessary to be able to select options for each detailed function.

As described above, in the second embodiment of the present technology, the terminal 40 issues a connection request to the core network 10 in a state where the default core network 10 exists. Thus, the function such as the inquiry and the like of the PLMN-ID is only required to be provided in the core network 10, it is not necessary to change the base station device 30, and the existing base station device 30 can be used as it is. Furthermore, the connection between the base station device 30 and the core network 10 has already been established, and the trouble of establishing a new connection can be saved.

### 3. Third Embodiment

In a case where the base station device 30 is used as a shared base station, it is desirable to give permission to use the base station device 30 for each terminal. This is because contract-based permission of use, such as roaming between operators, complicates the procedure. In the third embodiment, an example of receiving permission to use the base station device 30 for each terminal will be described. Note that the overall configuration of the communication system is similar to that of the first and second embodiments described above, and thus detailed description thereof will be omitted.

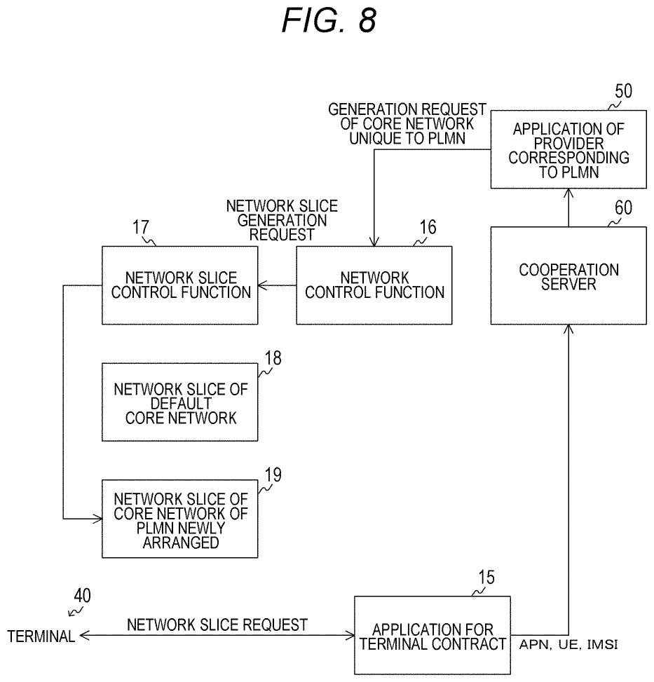

FIG. 8 is a diagram of an example of a network slice generation process according to the third embodiment of the present technology.

In this third embodiment, it is assumed that the application 15 for the terminal contract is arranged inside the default core network 10. This example presupposes the second embodiment, but may presuppose the first embodiment.

The terminal 40 performs a payment procedure and the like for using the base station device 30 via the application 15. The procedure for whether or not the base station device 30 can be used as a shared base station is processed in the application layer. Upon completion of the payment on a Web screen of the terminal 40 and the like, the application 15 inquires the cooperation server 60 for the PLMN-ID. This inquiry includes an identifier (cell ID) of the base station device 30 and the connection destination information (APN) of the terminal 40. Furthermore, the SIM information such as the IMSI and the like of the terminal 40 is transmitted for the authentication function 520 to perform authentication with the default core network 10. With this configuration, the terminal 40 can allow the desired arrangement of the core network.

[Operation]

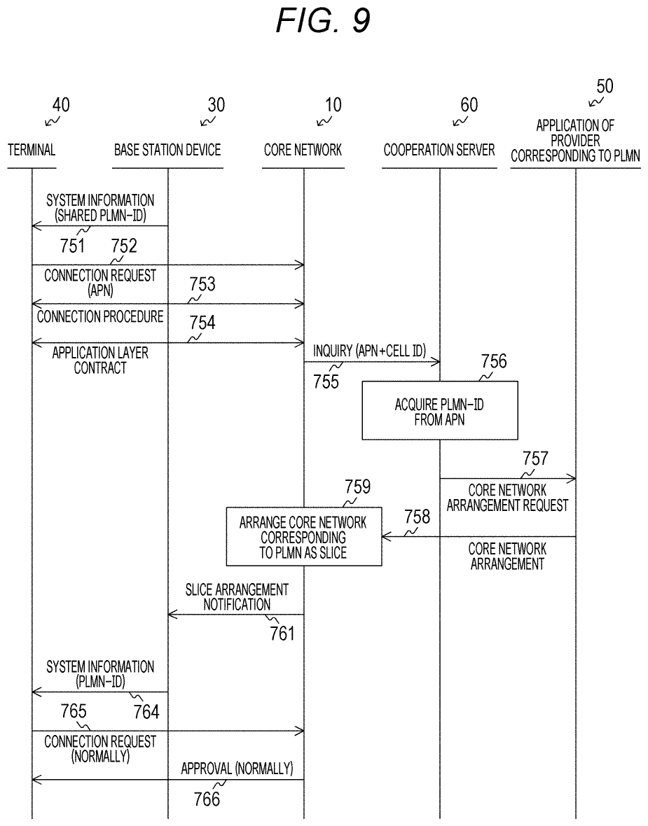

FIG. 9 is a sequence diagram of an example of processing of the communication system according to the third embodiment of the present technology.

This example presupposes the second embodiment described above, and is similar to that described above, except that a connection procedure (753) and a contract procedure in the application layer (754) are specified. The connection procedure (753) is similar to the conventional case, and the processing necessary for a connection between the terminal 40 and the core network 10 is performed.

The contract procedure (754) for permission of use in the application layer is a payment procedure and the like via the application 15 described above. Upon completion of the payment on the Web screen of the terminal 40 and the like, the application 15 of the core network 10 inquires the cooperation server 60 for the PLMN-ID (755).

As described above, in the third embodiment of the present technology, the permission of use of the base station device 30 as a shared base station is granted for each terminal in the first and second embodiments described above, and this can simplify the procedure.

### 4. Fourth Embodiment

In the above embodiment, if the terminal 40 moves and enters a range of a cell of another base station device, a new core network has to be created by the above procedure. However, it takes time, complicates the processing, and is inefficient to arrange a core network by repeating a similar procedure every time the terminal 40 moves. Thus, in the fourth embodiment, by grouping the base station devices, even if the terminal 40 moves between the base station devices, the terminal 40 can perform wireless transmission and reception seamlessly.

[Operation]

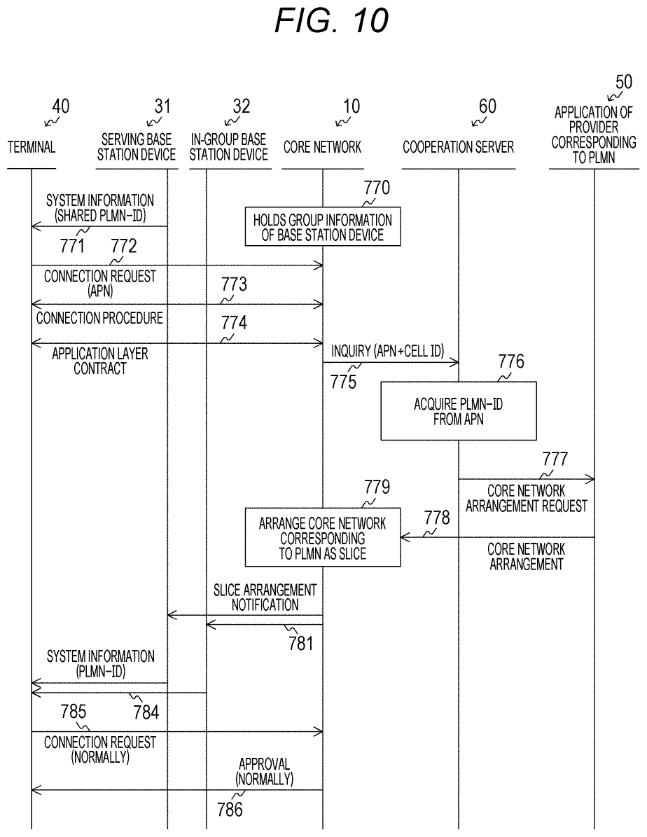

FIG. 10 is a sequence diagram of an example of processing of a communication system according to the fourth embodiment of the present technology.

In the fourth embodiment, a plurality of base station devices is grouped and managed. It is desirable that ones of the plurality of base station devices in the group be installed adjacent to each other within a predetermined range. A group ID indicating the group to which the base station device belongs is assigned to each of the base station devices. The core network 10 holds group information of the grouped base station devices and keeps track of the base station devices belonging to each group (770). The group ID may be represented as, for example, a high-order bit in the cell ID.

The base station device 31 periodically broadcasts the system information including the network identifier of the default core network 10 as a shared network identifier (771). The terminal 40 transmits a connection request including the connection destination information (APN) to the core network 10 using the network identifier of the default core network 10 (772). Thereafter, the connection procedure (773) and the contract procedure (774) in the application layer are performed.

The core network 10 inquires the cooperation server 60 for the PLMN-ID (775). The cooperation server 60 acquires the PLMN-ID corresponding to the connection destination information (APN) of the terminal 40 (776), and requests the application 50 to arrange the core network (777). In response, the application 50 requests the core network 10 to arrange a core network that corresponds to the PLMN-ID (778). With this configuration, the network slice in the core network 10 is arranged as the core network corresponding to the PLMN-ID (779).

The core network 10 notifies the base station device that a new core network of PLMN-ID corresponding to the requested connection destination information (APN) has been arrange in a form of a network slice (781). At that time, the base station device to be notified includes not only the base station device 31 serving the connection but also a grouped neighboring base station device 32. With this configuration, the base station devices 31 and 32 broadcast the system information including the unique network identifier corresponding to the provider (784). Thus, the terminal 40 can perform wireless transmission and reception seamlessly even if the terminal 40 moves between the base station devices 31 and 32.

As described above, in the fourth embodiment of the present technology, by grouping the base station devices, the wireless service is not interrupted even if the terminal 40 moves between the base station devices.

### 5. Fifth Embodiment

In the fourth embodiment described above, it is possible to use all the grouped neighboring base station devices by granting a permission of use of the base station devices once. However, the neighboring base station device is not necessarily owned by the same owner, and thus permission to use each base station device may be required in some cases. However, it takes time, complicates the processing, and is inefficient to newly arrange a core network by repeating a similar procedure. Thus, the fifth embodiment intends to maintain the service to be provided using the network slice by performing the procedure for permission of use between the core networks.

[Operation]

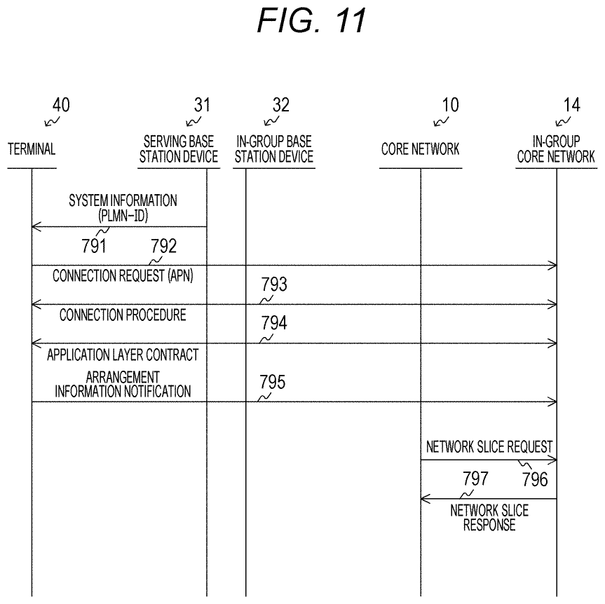

FIG. 11 is a sequence diagram of an example of processing of a communication system according to the fifth embodiment of the present technology.

It is assumed that the core network 10 for connecting to one base station device 31 has been already arranged (791). In that state, when the terminal 40 moves to a range of the neighboring base station device 32, the terminal 40 connects to the default core network 14 of a destination via the base station device 32 of the destination (792 and 793) and concludes a contract for permission of use in the application layer (794).

Thereafter, the terminal 40 notifies the core network 14 of information on the network slice in the core network 10 that has been already arranged (795). Upon receipt of the notification, the core network 14 of the destination requests for a permission application for using a network slice arranged in a neighboring core network, and obtains the permission (796 and 797). This configuration eliminates the need for creating a new network slice and makes it possible to provide a rapid service of the core network.

As described above, in the fifth embodiment of the present technology, the service of the core network can be maintained without creating a new network slice by performing the procedure for permission of use between the core networks.

That is, in these embodiments of the present technology, a terminal that has contracted with any operator in the world can be connected to the network by arranging one base station device. Each operator is only required to arrange the network function (core network or network slice) when using the terminal, and this allows operation at low cost.

Note that the above embodiments show examples for embodying the present technology, and the matters in the embodiments and the matters specifying the invention in the claims have a corresponding relationship with each other. Similarly, the matters specifying the invention within the claims and the matters in the embodiments of the present technology having the same names have a corresponding relationship with each other. However, the present technology is not limited to the embodiments, and can be embodied by applying various modifications to the embodiments without departing from the gist of the embodiments.

Further, the processing procedure described in the above embodiments may be regarded as a method having these series of procedures, as a program for causing a computer to execute these series of procedures, or as a recording medium for storing the program. As this recording medium, for example, a compact disc (CD), mini disc (MD), digital versatile disc (DVD), memory card, Blu-ray (registered trademark) disc, and the like can be used.

Note that the effects herein described are merely examples and are not limited, and furthermore, other effects may be obtained.

Note that the present technology can have the following configurations.

(1) A communication system including

a base station device configured to transmit a shared network identifier that is commonly used,

a communication device configured to issue a connection request using own connection destination information upon receipt of the shared network identifier,

a server configured to acquire and supply a unique network identifier corresponding to the connection destination information associated with the connection request, and

a network configuration apparatus configured to constitute and arrange a network function on the basis of the unique network identifier that has been supplied.

(2) A network configuration apparatus that is supplied with a unique network identifier corresponding to information provided by a communication device, and constitutes and arranges a network function on the basis of the unique network identifier that has been supplied.

(3) The network configuration apparatus according to (2),

in which the information provided by the communication device is connection destination information of the communication device.

(4) The network configuration apparatus according to (2) or (3),

in which the connection destination information is an access point name (APN).

(5) The network configuration apparatus according to any of (2) to (4),

in which the unique network identifier is supplied from a server as corresponding to the information provided by the communication device.

(6) The network configuration apparatus according to any of (2) to (5),

in which the information provided by the communication device is provided to the server by a base station device that transmits a shared network identifier that is commonly used.

(7) The network configuration apparatus according to (6),

in which the information provided by the communication device includes SIM information, and

the base station device is authenticated as valid on the basis of the SIM information.

(8) The network configuration apparatus according to any of (2) to (5),

in which the information provided by the communication device is provided to the server by a network corresponding to a shared network identifier that is commonly used.

(9) The network configuration apparatus according to (8),

in which the information provided by the communication device includes SIM information, and

the network corresponding to the shared network identifier is authenticated as valid on the basis of the SIM information.

(10) The network configuration apparatus according to any of (2) to (7),

in which the network function arranged on the basis of the unique network identifier is a new core network.

(11) The network configuration apparatus according to (10),

configured to receive information associated with where the new core network is to be arranged.

(12) The network configuration apparatus according to (11),

in which the information associated with where the new core network is to be arranged includes information associated with a location of the base station device that transmits a shared network identifier that is commonly used, and

the new core network is arranged at a predetermined distance with respect to the location of the base station device.

(13) The network configuration apparatus according to any of (2) to (5), (8), or (9),

in which the network function arranged on the basis of the unique network identifier is a new network slice of an existing core network.

(14) The network configuration apparatus according to any of (2) to (13),

in which the information is provided by the communication device, and then an application layer performs a use permission procedure necessary for using a base station device.

(15) The network configuration apparatus according to (14),

in which the use permission procedure includes a payment procedure of a cost of using the base station device.

(16) The network configuration apparatus according to any of (2) to (15),

in which the network function is arranged on the basis of the unique network identifier, and then the unique network identifier is transmitted from a plurality of base station devices in the same group.

(17) The network configuration apparatus according to (16),

in which any of the plurality of base station devices are installed adjacent to each other within a predetermined range.

(18) The network configuration apparatus according to 16 or 17,

in which in a state where a plurality of the network functions is arranged, a use permission procedure necessary for using another base station device among the plurality of base station devices is performed among the plurality of network functions.

(19) A server including

a storage unit configured to store connection destination information of a communication device and a unique network identifier corresponding to the connection destination information in association with each other, and

a supply unit configured to acquire the unique network identifier corresponding to the connection destination information provided by the communication device from the storage unit and configured to supply the unique network identifier.

### REFERENCE SIGNS LIST

10, 14 Core network
11 to 13, 18, 19 Network slice
15 Application
16 Network control function
17 Network slice control function
30 to 32 Base station device
40 Terminal
50 Application
510 Core network arrangement request reception function
520 Authentication function
530 Core network configuration function
60 Cooperation server
610 Storage unit
620 Supply unit

1. A communication system comprising:
a base station device configured to transmit a shared network identifier that is commonly used;
a communication device configured to issue a connection request using own connection destination information upon receipt of the shared network identifier;
a server configured to acquire and supply a unique network identifier corresponding to the connection destination information associated with the connection request; and
a network configuration apparatus configured to constitute and arrange a network function on a basis of the unique network identifier that has been supplied.

2. A network configuration apparatus that is supplied with a unique network identifier corresponding to information provided by a communication device, and constitutes and arranges a network function on a basis of the unique network identifier that has been supplied.

3. The network configuration apparatus according to claim 2,
wherein the information provided by the communication device is connection destination information of the communication device.

4. The network configuration apparatus according to claim 3,
wherein the connection destination information is an access point name (APN).

5. The network configuration apparatus according to claim 2,
wherein the unique network identifier is supplied from a server as corresponding to the information provided by the communication device.

6. The network configuration apparatus according to claim 5,
wherein the information provided by the communication device is provided to the server by a base station device that transmits a shared network identifier that is commonly used.

7. The network configuration apparatus according to claim 6,
wherein the information provided by the communication device includes SIM information, and
the base station device is authenticated as valid on a basis of the SIM information.

8. The network configuration apparatus according to claim 5,
wherein the information provided by the communication device is provided to the server by a network corresponding to a shared network identifier that is commonly used.

9. The network configuration apparatus according to claim 8,
wherein the information provided by the communication device includes SIM information, and
the network corresponding to the shared network identifier is authenticated as valid on a basis of the SIM information.

10. The network configuration apparatus according to claim 2,
wherein the network function arranged on a basis of the unique network identifier is a new core network.

11. The network configuration apparatus according to claim 10,
configured to receive information associated with where the new core network is to be arranged.

12. The network configuration apparatus according to claim 11,
wherein the information associated with where the new core network is to be arranged includes information associated with a location of the base station device that transmits a shared network identifier that is commonly used, and
the new core network is arranged at a predetermined distance with respect to the location of the base station device.

13. The network configuration apparatus according to claim 2,
wherein the network function arranged on a basis of the unique network identifier is a new network slice of an existing core network.

14. The network configuration apparatus according to claim 2,
wherein the information is provided by the communication device, and then an application layer performs a use permission procedure necessary for using a base station device.

15. The network configuration apparatus according to claim 14,
wherein the use permission procedure includes a payment procedure of a cost of using the base station device.

16. The network configuration apparatus according to claim 2,
wherein the network function is arranged on a basis of the unique network identifier, and then the unique network identifier is transmitted from a plurality of base station devices in a same group.

17. The network configuration apparatus according to claim 16,
wherein any of the plurality of base station devices are installed adjacent to each other within a predetermined range.

18. The network configuration apparatus according to claim 16,
wherein in a state where a plurality of the network functions is arranged, a use permission procedure necessary for using another base station device among the plurality of base station devices is performed among the plurality of network functions.

19. A server comprising:
a storage unit configured to store connection destination information of a communication device and a unique network identifier corresponding to the connection destination information in association with each other; and
a supply unit configured to acquire the unique network identifier corresponding to the connection destination information provided by the communication device from the storage unit and configured to supply the unique network identifier.
